(19) United States
(12) Patent Application Publication
(10) Pub. No.: US 2025/0055974 A1
(43) Pub. Date: Feb. 13, 2025

(54) ERROR DETECTION AND HANDLING IN PROCESSING IMAGE DATA

(71) Applicant: QUALCOMM Incorporated, San Diego, CA (US)

(72) Inventors: Vinod Kumar NAHVAL, Mountain House, CA (US); Rohan DESAI, San Diego, CA (US); Mei YANG, San Diego, CA (US)

(21) Appl. No.: 18/447,782

(22) Filed: Aug. 10, 2023

(51) Int. Cl. H04N 17/00; G06T 7/00

(52) U.S. Cl. CPC H04N 17/002; G06T 7/0002

(57) ABSTRACT

Systems and techniques are described herein for processing image data. For instance, an apparatus for processing image data is provided. The apparatus may include an image-signal processor (ISP) configured to process first image data of a data stream and to process second image data of the data stream; and a reset controller configured to, in response to a detected error related to the first image data, reset the first image data in a memory of the ISP while maintaining the second image data in the memory of the ISP.

### TECHNICAL FIELD

The present disclosure generally relates to error detection and handling in processing image data. For example, aspects of the present disclosure include systems and techniques for detecting and handling errors in multi-context image processing.

### BACKGROUND

A camera may focus light onto an image sensor that may generate image data representative of the light. The image data may represent images, such as still images and/or video frames. Image signal processors (ISPs) may receive image data (e.g., raw image data from an image sensor) and process the image data, for example, to perform operations related to, as examples, Bayer transformations, demosaicing, noise reduction, and/or image sharpening.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing image data. According to at least one example, an apparatus is provided for processing image data The apparatus includes: an image-signal processor (ISP) configured to process first image data of a data stream and to process second image data of the data stream; and a reset controller configured to, in response to a detected error related to the first image data, reset the first image data in a memory of the ISP while maintaining the second image data in the memory of the ISP.

In another example, a method for processing image data is provided that includes: processing, at an image-signal processor (ISP), first image data of a data stream; processing, at the ISP, second image data of the data stream; and responsive to detecting an error related to the first image data, resetting the first image data in a memory of the ISP while maintaining the second image data in the memory of the ISP.

In another example, a non-transitory computer-readable medium is provided that has stored thereon instructions that, when executed by one or more processors, cause the one or more processors to: process, at an image-signal processor (ISP), first image data of a data stream; process, at the ISP, second image data of the data stream; and responsive to detecting an error related to the first image data, reset the first image data in a memory of the ISP while maintaining the second image data in the memory of the ISP.

In another example, an apparatus for processing image data is provided. The apparatus includes: means for processing, at an image-signal processor (ISP), first image data of a data stream and processing, at the ISP, second image data of the data stream and means for responsive to detecting an error related to the first image data, resetting the first image data in a memory of the ISP while maintaining the second image data in the memory of the ISP.

In another example, an apparatus for processing image data is provided that includes at least one memory and at least one processor (e.g., configured in circuitry) coupled to the at least one memory. The at least one processor configured to: process, at an image-signal processor (ISP), first image data of a data stream; process, at the ISP, second image data of the data stream; and responsive to detecting an error related to the first image data, reset the first image data in a memory of the ISP while maintaining the second image data in the memory of the ISP.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image processing system, according to various aspects of the present disclosure;

FIG. 2 illustrates a block diagram illustrating an example system including an multiple image sensors and an image processor, according to various aspects of the present disclosure;

FIG. 3 illustrates multiple example images, captured by a single image sensor, with different image-capture settings that may be used to create a composite image, according to various aspects of the present disclosure;

FIG. 4 is a perspective diagram of a system including a vehicle that includes multiple cameras, according to various aspects of the present disclosure;

FIG. 5 is a block diagram illustrating portions of image data that may be provided to an image processor in an interleaved manner, according to various aspects of the present disclosure;

FIG. 6 is a diagram illustrating a system for processing image data, according to various aspects of the present disclosure;

FIG. 7 is a diagram illustrating a system for processing image data, according to various aspects of the present disclosure;

FIG. 8 is a flow diagram illustrating a process for handling errors in an image processing system, in accordance with aspects of the present disclosure; and

FIG. 9 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, an image sensor may generate image data and an image signal processor (ISP) may process the image data. An ISP may receive and process multiple sets of image data. As an example, an ISP may receive respective sets of image data from two or more respective image sensors. For instance, an ISP in a vehicle computing system may receive respective sets of image data from each image sensor of a number of image sensors of the vehicle. As another example, a single image sensor may provide an ISP with multiple sets of image data. For example, an image sensor may capture short-exposure image data and long-exposure image data and may provide the short-exposure and long-exposure image data to an ISP (e.g., for the ISP to generate a composite image based on both the short-exposure image data and the long-exposure image data).

Using a single ISP to process image data from multiple image sensors (or to process multiple sets of image data from a single sensor) may conserve space of components (e.g., integrated circuits, chipsets, etc.) in devices or systems compared with other systems that include one ISP per image sensors (or one ISP per type of image data captured by an image sensor). For example, an integrated circuit that includes one ISP to process image data from multiple image sensors may conserve space on the integrated circuit as compared with an integrated circuit with one ISP for each image sensor. As another example, an integrated circuit that includes one ISP to process multiple types of image data from a single image sensor may conserve space on the integrated circuit compared with an integrated circuit that includes one ISP for each type of image data.

In some cases, an ISP may receive and process sets of image data serially. For example, the ISP may process one set of image data entirely before processing a second set of image data. In other cases, some ISPs may be configured to receive and process two or more sets of image data in an interleaved manner. For example, such an ISP may be configured to receive a portion of first image data (e.g., one or more lines of a first image) to store the portion of the first image data at a first location of a memory of the ISP, to process the portion of the first image, and to output a processed portion of the first image data (e.g., one or more processed lines of the first image). Following the outputting of the processed portion of the first image data, and before receiving another portion of the first image data, the ISP may be configured to receive and process a portion of second image data. For example, the ISP may be configured to receive a portion of second image data (e.g., one or more lines of a second image) to store the portion of the second image data at a second location of the memory of the ISP, to process the portion of the second image, and to output a processed portion of the second image data (e.g., one or more processed lines of the second image). Following the outputting of the processed portion of the second image data, and before receiving another portion of the second image data, the ISP may be configured to receive and process a portion of third image data or a portion of the first image data.

In the present disclosure, receipt of, storage of, processing of, and/or outputting of a set of image data may be referred to using the term “context.” For example, an ISP may receive, store, process, and output first image data. The operations and memory locations associated with the first image data may be referred to as a first context. The ISP may also receive, store, process, and output second image data (e.g., in a time-interleaved manner with regard to the first imaged data). The operations and memory locations associated with the second image data may be referred to as a second context. Thus, the ISP may be performing multi-context image processing (e.g., processing the first context and the second context in an interleaved manner).

In some cases, processing sets of image data by an ISP in an interleaved manner may rely on a provider of the image data. For example, the provider may provide the sets of image data in an interleaved manner (e.g., interleaving portions from respective sets of image data) and the ISP may operate on the image data as the image data is received. As an example, an aggregator may receive first image data and second image data and combine the first image data and the second image data into an interleaved data stream (e.g., with portions of the second image data interleaved between portions of the first image data). The ISP may process the portions as the portions are received.

One challenge in multi-context image processing is error detection and handling. Examples of errors that may occur in images processing include sensor errors (e.g., an image sensor fails partway through generating an image frame) and ISP errors (e.g., an intellectual property (IP) block of an ISP takes longer than expected processing a portion of image data). In conventional image processing systems, if an error is detected, the ISP and/or a decoder associated with the image sensor is reset. For example, a memory of the ISP and/or a memory of the decoder is reset. For instance, an offset indicating a location of the memory for storage of incoming data (and/or for reading data) is reset such that incoming data overwrites previously-stored data (the previously-stored data being associated with an error). If an ISP were performing multi-context image processing, resetting the memory of the ISP would reset all of the contexts.

Systems, apparatuses, methods (also referred to as processes), and computer-readable media (collectively referred to herein as “systems and techniques”) are described herein for error detection and handling for multi-context image processing. The systems and techniques described herein may include per-context error detection and/or handling. As an example, the systems and techniques may detect an error in one context of a multi-context image processing system (including multiple contexts) and reset the context without resetting other contexts of the multiple contexts. For instance, the systems and techniques may, in response to detecting an error related to first image data, reset the first image data in a memory of the ISP while maintaining second image data in the memory of the ISP.

In one illustrative example, the systems and techniques may receive the first image data in a data stream and store the first image data at a first location in a memory of the ISP. The systems and techniques may process the first image data from the first location in the memory of the ISP. The systems and techniques may receive the second image data in the data stream and store the second image data at a second location in the memory of the ISP. The systems and techniques may then process the second image data from the second location in the memory of the ISP. In response to detecting an error related to the first image data, the systems and techniques may reset the first image data at the first location in the memory of the ISP while maintaining the second image data at the second location in the memory of the ISP. For example, the systems and techniques may reset an offset corresponding to the first location such that incoming third image data (e.g., from the image sensor that generated the first image data or of the same type as the first image data) is written at the first location in the memory of the ISP. Further, subsequent to the reset controller resetting the first image data in the memory of the ISP core, the systems and techniques may receive second image data, store the second image data at the second location, and/or process the second image data (e.g., despite having reset the first image data). In this way, the systems and techniques reset the first image data without interfering with the second image data.

In some cases, the systems and techniques may reset decoders and/or an aggregator. For example, in addition to resetting memory of the ISP on a per-context basis, the systems and techniques may reset decoders and/or an aggregator on a per context basis. For instance, if an error is detected related to first image data, the systems and techniques may provide a reset signal to the decoder that is associated with the first image data (e.g., the decoder that generated the first image data from raw image data from an image sensor). Additionally, or alternatively, the systems and techniques may provide a reset signal to an aggregator.

In some cases, the systems and techniques may detect errors. For example, the systems and techniques may include error detectors in decoders to detect sensor errors. Additionally, or alternatively, the systems and techniques may include error detectors in the ISP (e.g., following intellectual property (IP) blocks of the ISP) to detect ISP errors. The systems and techniques may reset memories based on detecting sensor errors and/or ISP errors.

Various aspects of the application will be described with respect to the figures below.

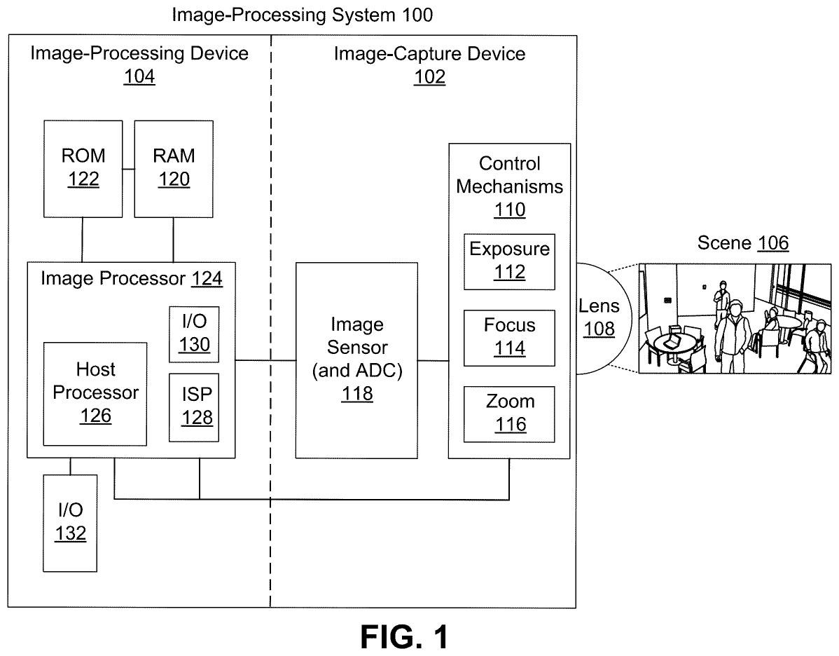

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

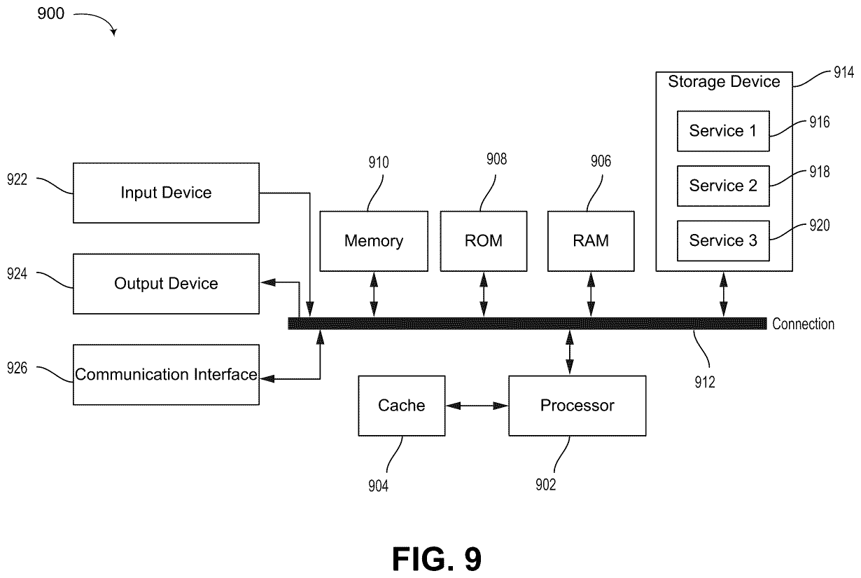

The image processor 124 may include one or more processors, such as one or more image signal processors (ISPs) (including ISP 128), one or more host processors (including host processor 126), and/or one or more of any other type of processor discussed with respect to the computing-device architecture 900 of FIG. 9. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 900 shown in FIG. 9 and further described below can include the image-processing system 100, the image-capture device 102, the image-processing device 104, or a combination thereof.

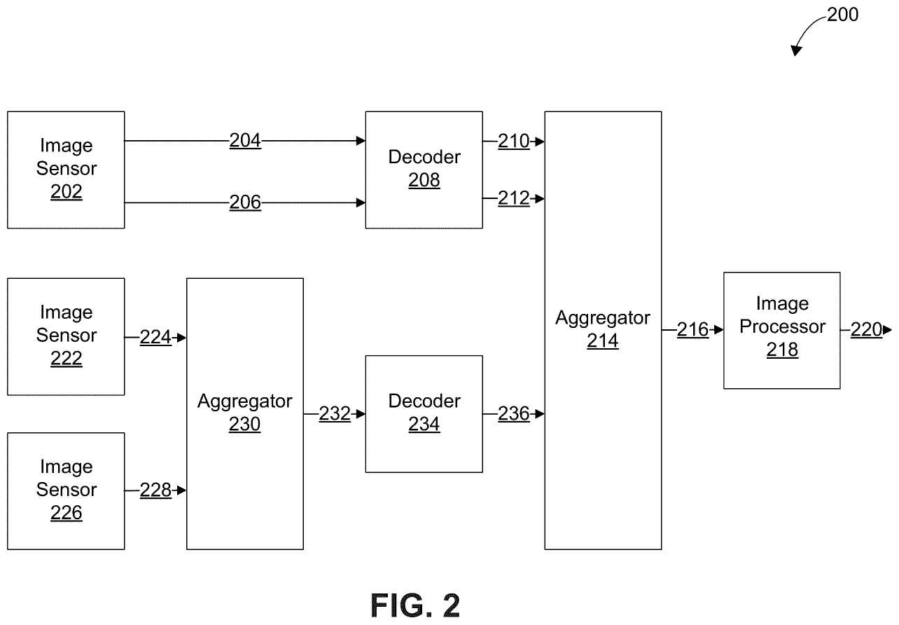

FIG. 2 illustrates a block diagram illustrating an example system 200 including an image sensor 202, an image sensor 222, an image sensor 226 and an image processor 218, according to various aspects of the present disclosure. Each of image sensor 202, image sensor 222, and image sensor 226 may be an example of image-capture device 102 of FIG. 1 or of image sensor 118 of FIG. 1. Image processor 218 may be an example of image-processing device 104 of FIG. 1 or of image processor 124 of FIG. 1. Image processor 218 may process image data 210 and image data 212 from image sensor 202 and/or image data 236 from image sensor 222 and image sensor 226. Accordingly, system 200 provides examples of multi-context image processing.

As a first example of multi-context image processing, image sensor 202 may generate raw image data 204 and raw image data 206. Raw image data 204 and raw image data 206 may be image data of separate images (e.g., captured at different times and, in some cases, using different image-capture settings, such as different exposures). Decoder 208 may decode raw image data 204 to generate image data 210 and may decode raw image data 206 to generate image data 212. Aggregator 214 may aggregate image data 210 and image data 212 to generate data stream 216. In some cases, aggregator 214 may further aggregate image data 210 and image data 212 with other image data (e.g., image data 236) to generate data stream 216. Data stream 216 may include image data 210 and image data 212 (and/or other image data) (e.g., in an interleaved manner). Image processor 218 may process image data 210 and image data 212 (e.g., in an interleaved manner) as image data 210 and image data 212 are received in data stream 216. For example, image processor 218 may perform Bayer transformations, demosaicing, noise reduction, and/or image sharpening on image data 210 and on image data 212 to generate processed image data 220. Processed image data 220 may be a data stream including processed image data 210 and processed image data 212. Image data 210 and image data 212 may be examples of two separate contexts. Image processor 218 store image data 210 and image data 212 in two respective locations in a memory of image processor 218 and may process image data 210 and image data 212 separately from the two locations.

As a second example of multi-context image processing, image sensor 222 may generate raw image data 224 and image sensor 226 may generate raw image data 228. Aggregator 230 may aggregate raw image data 224 and raw image data 228 to generate raw data stream 232 (which may include raw image data 224 and raw image data 228). Decoder 234 may decode raw image data 224 and raw image data 228 to generate decoded image data 236. Decoded image data 236 may include decoded raw image data 224 and decoded raw image data 228. In some cases, aggregator 214 may aggregate decoded image data 236 with other image data (e.g., image data 210 and/or image data 212) to generate data stream 216. Data stream 216 may include decoded raw image data 224 and decoded raw image data 228 (and/or other image data) (e.g., in an interleaved manner). Image processor 218 may process decoded raw image data 224 and decoded raw image data 228 (e.g., in an interleaved manner) as decoded raw image data 224 and decoded raw image data 228 are received in data stream 216. For example, image processor 218 may perform Bayer transformations, demosaicing, noise reduction, and/or image sharpening on decoded raw image data 224 and decoded raw image data 228 to generate processed image data 220. Processed image data 220 may be a data stream including processed decoded raw image data 224 and processed decoded raw image data 228. Raw image data 224 and raw image data 228 may be examples of two separate contexts. Image processor 218 store decoded raw image data 224 and decoded raw image data 228 in two respective locations in a memory of image processor 218 and may process decoded raw image data 224 and decoded raw image data 228 separately from the two locations.

To enable image processor 218 to process multiple contexts, aggregator 214 may tag image data as the image data is added to data stream 216. For example, aggregator 214 may tag image data 210 with a first tag, image data 212 with a second tag, decoded raw image data 224 with a third tag, and decoded raw image data 228 with a fourth tag. Image processor 218 may use the tags to correlate image data from the same source (or of the same context).

System 200 may include any number of image sensors, decoders, and/or aggregators. Further, the image sensors may be configured to capture any number of separate sets of image data. System 200 may process any number of contexts.

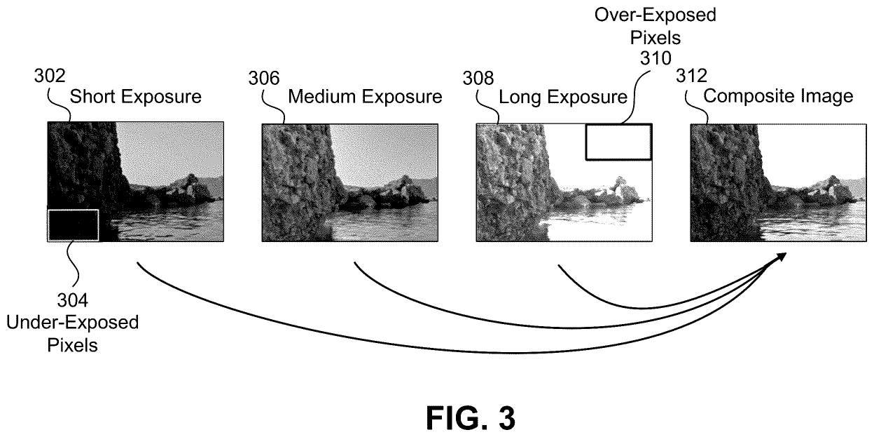

FIG. 3 illustrates multiple example images, captured by a single image sensor, with different image-capture settings that may be used to create a composite image 312, according to various aspects of the present disclosure. In particular, FIG. 3 shows a short-exposure image 302, a medium-exposure image 306, a long-exposure image 308, and composite image 312. Composite image 312 may be generated by combining portions of the short-exposure image 302, portions of medium-exposure image 306, and portions of the long-exposure image 308. Short-exposure image 302 includes under-exposed pixels 304, and the long-exposure image 308 includes over-exposed pixels 310. As shown in FIG. 3, composite image 312 includes pixels from short-exposure image 302, but not under-exposed pixels 304, and pixels from long-exposure image 308, but not over-exposed pixels 310.

Short-exposure image 302, medium-exposure image 306, and long-exposure image 308 (or image data representing short-exposure image 302, medium-exposure image 306, and long-exposure image 308 respectively) may be captured by the same image sensor (e.g., image sensor 118 of image-capture device 102 of FIG. 1 or image processor 218 of FIG. 2). Further, short-exposure image 302, medium-exposure image 306, and long-exposure image 308 (or image data representing short-exposure image 302, medium-exposure image 306, and long-exposure image 308 respectively) may be provided to the same ISP (e.g., image processor 124 of image-processing device 104 of FIG. 1 or image processor 218 of FIG. 2). The ISP may process short-exposure image 302, medium-exposure image 306, and long-exposure image 308. In some cases, the ISP may generate composite image 312 based on short-exposure image 302, medium-exposure image 306, and long-exposure image 308.

Processing short-exposure image 302 at an ISP may be an example of a first context. Processing medium-exposure image 306 at the ISP may be an example of a second context. Processing long-exposure image 308 at the ISP may be an example of a third context.

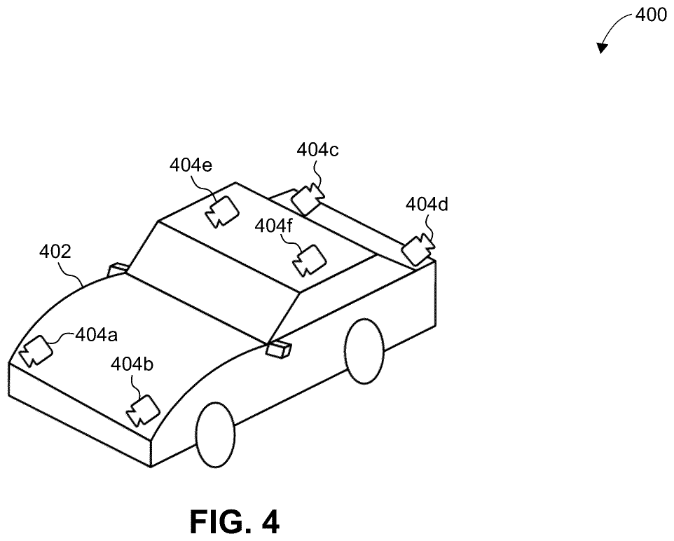

As an example, FIG. 4 is a perspective diagram of a system 400 including a vehicle 402 that includes multiple cameras 404, according to various aspects of the present disclosure. Vehicle 402 may include one or more instances of imaging system 100 of FIG. 1. Additionally, or alternatively, vehicle 402 may include multiple image-capture devices 102 and multiple image-processing devices 104 (e.g., fewer image-processing devices 104 than image-capture devices 102). Vehicle 402 may be, for example, an automobile, a truck, a bus, a train, a ground-based vehicle, an airplane, a helicopter, an aircraft, an aerial vehicle, a boat, a submarine, a watercraft, an underwater vehicle, a hovercraft, or a combination thereof. In some examples, vehicle 402 may be manned. In some examples, vehicle 402 may be unmanned, autonomous, and/or semi-autonomous. In some examples, the vehicle may be at least partially controlled and/or used with sub-systems of vehicle 402, such as advance driver assistance system (ADAS) of vehicle 402, in-vehicle infotainment (IVI) systems of the vehicle 402, autonomous driving systems of the vehicle 402, semi-autonomous driving systems of the vehicle 402, a vehicle electronic control unit (ECU) of vehicle 402, or a combination thereof.

Vehicle 402 includes a first camera 404a and a second camera 404b at the front, a third camera 404c and a fourth camera 404d at the rear, and a fifth camera 404e and a sixth camera 404f on the top. First camera 404a, a second camera 404b, third camera 404c, fourth camera 404d, a fifth camera 404c, and a sixth camera 404f may be referred to collectively as cameras 404. In some examples, vehicle 402 may include additional cameras in addition to the cameras illustrated in FIG. 4. In some examples, vehicle 402 may omit some of the cameras that are illustrated in FIG. 4.

Any of all of the cameras 404 may provide image data (e.g., raw image data and/or partially processed image data) to one or more ISPs. In some cases, two or more of cameras 404 may provide image data to one ISP. For example, in some cases, all of cameras 404 may provide image data to a single ISP. As another example, first camera 404a and second camera 404b may provide image data to a first ISP, third camera 404c and fourth camera 404d may provide image data to a second ISP, and fifth camera 404c and sixth camera 404f may provide image data to a third ISP.

Processing image data from first camera 404a at an ISP may be an example of a first context. Processing image data from second camera 404b at the ISP may be an example of a second context. Processing image data from third camera 404c at the ISP may be an example of a third context. Processing image data from fourth camera 404d at the ISP may be an example of a fourth context. Processing image data from fifth camera 404e at the ISP may be an example of a fifth context. Processing image data from sixth camera 404f at the ISP may be an example of a sixth context.

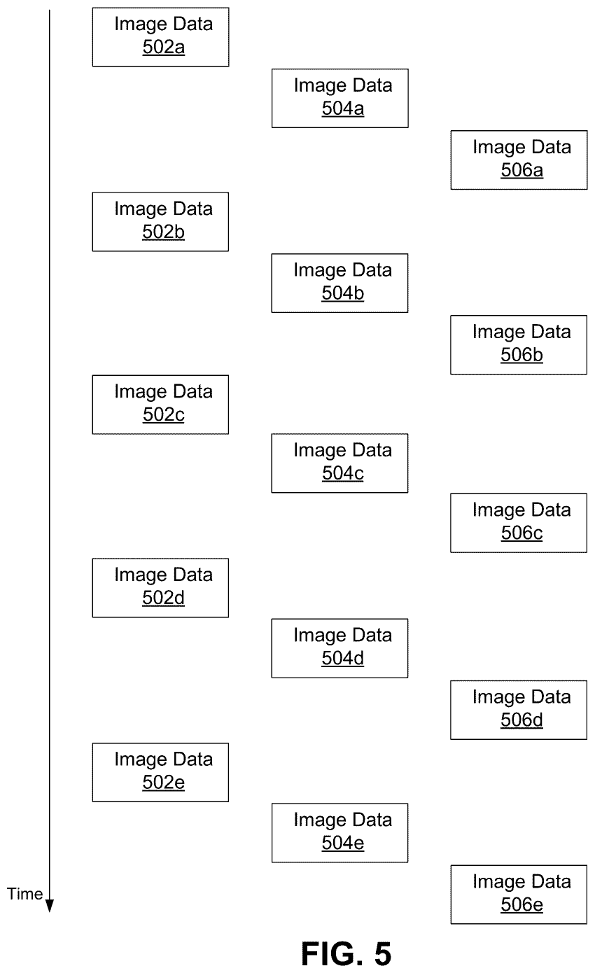

FIG. 5 is a block diagram illustrating portions of image data 502a, 502b, 502c, 502d, 502e (collectively referred to as image data 502), portions of image data 504a, 504b, 504c, 504d, 504c (collectively referred to as image data 504), and portions of image data 506a, 506b, 506c, 506d, 506e (collectively referred to as image data 506) that may be provided to an image processor in an interleaved manner, according to various aspects of the present disclosure. For example, image data 502 may include image-data portion 502a, image-data portion 502b, image-data portion 502c, image-data portion 502d, and image-data portion 502c. Each of image-data portion 502a, image-data portion 502b, image-data portion 502c, image-data portion 502d, and image-data portion 502e may be a respective portion of image data 502. For example, each of image-data portion 502a, image-data portion 502b, image-data portion 502c, image-data portion 502d, and image-data portion 502e may represent one or more lines of an image represented by image data 502. Similarly, image data 504 may include image-data portion 504a, image-data portion 504b, image-data portion 504c, image-data portion 504d, and image-data portion 504c, each of which may represent one or more lines of image data 504. Image data 506 may include image-data portion 506a, image-data portion 506b, image-data portion 506c, image-data portion 506d, and image-data portion 506e, each of which may represent one or more lines of image data 506. The number of lines included in each of the portions of the respective image data may, or may not, be consistent. For example, image-data portion 502a may include a first number of lines, image-data portion 502b may include a second number of lines. The second number of lines may be the same or may be different from the first number of lines. Image-data portion 502c may include a third number of lines that may be the same or different from the first number of lines and the same or different from the second number of lines.

Processing of image data 502 may be an example of a first context. Processing of image data 504 may be an example of a second context. Processing of image data 506 may be an example of a third context.

Three sets of image data (image data 502, image data 504, and image data 506) are illustrated for simplicity. An image processor may receive any number of sets of image data from any number of sources (including from one source). Further, five portions of each of the sets of image data 502, image data 504, and image data 506 are illustrated for simplicity. A set of image data (e.g., an image) may include any number of portions. For example, where each portion represents a line of an image, a set of image data may include 486, 576, 720, 1080, 2160, 3840, etc. portions. As another example, where each portion represents two lines of an image, a set of image data may include 243, 288, 360, 540, 1080, 1920, etc. portions. As another example, where each portion represents four lines of an image, a set of image data may include 144, 180, 270, 540, 960, etc. portions. However, noted above, the number of lines in each portion may not be consistent in some cases. In such cases, a set of image data may include any number of portions.

Image data 502, image data 504, and image data 506 are illustrated as arranged in time in an interleaved manner. For example, in FIG. 5, time may be represented in the vertical direction. As such, image data 502, image data 504, and image data 506 may be provided to an image processor in an interleaved manner, for example, in the following order, image-data portion 502a, image-data portion 504a, image-data portion 506a, image-data portion 502b, image-data portion 504b, image-data portion 506b, image-data portion 502c, image-data portion 504c, image-data portion 506c, image-data portion 502d, image-data portion 504d, image-data portion 506d, image-data portion 502e, image-data portion 504e, image-data portion 506e. Image data 502, image data 504, and image data 506 are illustrated as separated in the horizontal direction for illustrative purposes. Image data 502, image data 504, and image data 506 may all be provided to an image processor via a single interface.

An aggregator (e.g., aggregator 214 of FIG. 2) may receive image data 502, image data 504, and image data 506 from one or more sources. As an example, the aggregator may receive image data 502, image data 504, and image data 506 from a single image sensor (or decoder associated with the single image sensor). For example, image data 502 may be a short-exposure image (e.g., short-exposure image 302 of FIG. 3), image data 504 may be a medium-exposure image (e.g., medium-exposure image 306 of FIG. 3), and image data 506 may be a long-exposure image (e.g., long-exposure image 308 of FIG. 3). As another example, the aggregator may receive image data 502, image data 504, and image data 506 from three separate image sensors (or respective decoders associated with the three separate image sensors). For example, image data 502 may be from a first image sensor (e.g., first camera 404a of FIG. 4), image data 504 may be from a second image sensor (e.g., second camera 404b of FIG. 4), and image data 506 may be from a third image sensor (e.g., third camera 404c of FIG. 4).

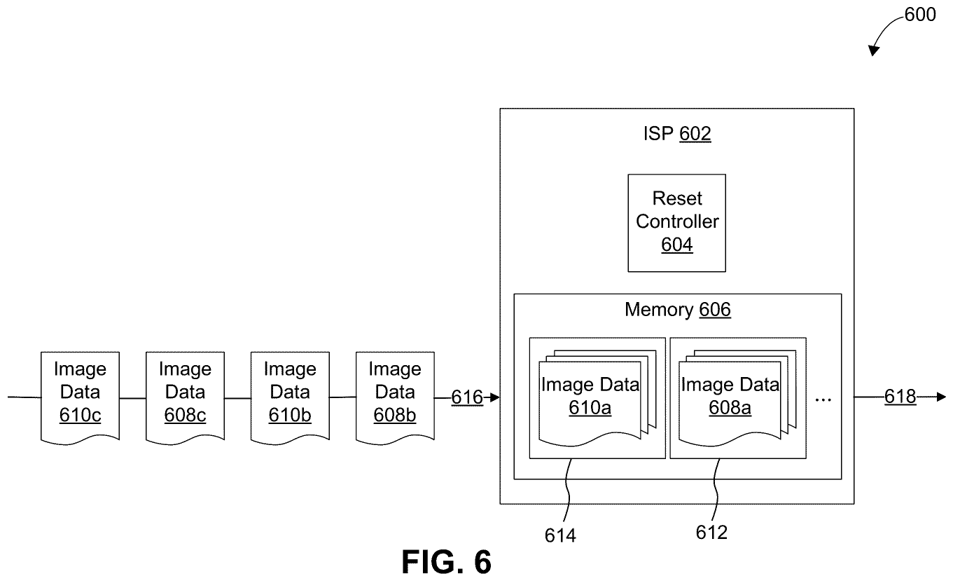

FIG. 6 is a diagram illustrating a system 600 for processing image data, according to various aspects of the present disclosure. System 600 includes an image-signal processor (ISP 602) configured to process image data (e.g., first image data 608 of a data stream 616 and second image data 610 of data stream 616). System 600 also includes a reset controller 604 configured to, in response to a detected error related to one of the image data, to reset processing of the one of the image data while maintaining the other of the image data. For example, reset controller 604 may, in response to detecting an error related to first image data 608, reset first image data 608 in a memory 606 of ISP 602 while maintaining second image data 610 in memory 606 of ISP 602. As another example, reset controller 604 may, in response to detecting an error related to second image data 610, reset second image data 610 in a memory 606 of ISP 602 while maintaining first image data 608 in memory 606 of ISP 602.

Image processor 124 of FIG. 1 and/or image processor 218 of FIG. 2 may be an example of ISP 602. ISP 602 may process first image data 608 and/or second image data 610 (as received in data stream 616) to generate processed image data 618 (which may include processed first image data 608 and/or processed second image data 610). ISP 602 may perform operations such as Bayer transformations, demosaicing, noise reduction, and/or image sharpening on first image data 608 and/or second image data 610.

First image data 608 may include multiple portions, for example, image data 608a, image data 608b, and image data 608c (which may be collectively referred to as first image data 608). Second image data 610 may include multiple portions, for example, image data 610a, image data 610b, and image data 610c (which may be collectively referred to as second image data 610). First image data 608 and second image data 610 may be received by ISP 602 in data stream 616 in an interleaved manner (e.g., as illustrated by FIG. 5). Each portion of first image data 608 may be tagged with a first tag correlating first image data 608 and each portion of second image data 610 may be tagged with a second tag correlating second image data 610. An aggregator (such as aggregator 214 of FIG. 2) may aggregate and tag first image data 608 and second image data 610.

ISP may process first image data 608 and second image data 610 in an interleaved manner (e.g., as first image data 608 and second image data 610 are received in data stream 616). For example, ISP 602 may store received portions of first image data 608 (e.g., image data 608a) at first location 612 in memory 606 of ISP 602 as the portions of first image data 608 are received. Further, ISP 602 may process image data 608a from first location 612 of memory 606 (e.g., as the portions are received and stored). Further, ISP 602 may output processed image data 608a as image data 608a is processed. Additionally, ISP 602 may store received portions of second image data 610 (e.g., image data 610a) at second location 614 in memory 606 of ISP 602 as the portions of second image data 610 are received. While two locations (first location 612 and second location 614) are shown in FIG. 6 for illustrative purposes, the memory 606 can include more locations. Further, ISP 602 may process image data 610a from second location 614 of memory 606 (e.g., as the portions are received and stored). ISP 602 may output processed image data 610a as image data 610a is processed. Processing first image data 608 may be a first context. Processing second image data 610 may be a second context.

In some cases, ISP 602 may process a certain size of first image data 608 or second image data 610 at a time. For example, ISP 602 may include a filter of a certain size (e.g., a five-by-five filter). In such cases, ISP 602 may store the certain size of first image data 608 and second image data 610 in memory 606. For example, if ISP 602 is configured to process five lines of first image data 608 at a time, ISP 602 may store the most recently-received five lines of first image data 608 at first location 612. For instance, ISP 602 may store five lines of first image data 608 and overwrite the oldest line of first image data 608 as a line is received.

ISP 602 may store offsets indicative of first location 612 and other offsets indicative of second location 614. For example, ISP 602 may store a first offset indicative of where in memory 606 to write newly-received portions of first image data 608. Further, ISP 602 may store a second offset indicative of where in memory 606 to read first image data 608. Further ISP 602 may store a third offset indicative of where in memory 606 to write second image data 610 and a fourth offset indicative of where in memory 606 to read second image data 610.

Reset controller 604 may perform per-context resetting. For example, reset controller 604 may reset processing of first image data 608 without affecting processing of second image data 610. For example, in response to an error detection related to first image data 608, reset controller 604 may reset first image data 608 at first location 612 in memory 606 of ISP 602 while maintaining second image data 610 at second location 614 in memory 606 of ISP 602. For example, reset controller 604 may reset offsets corresponding to the first location (e.g., offsets indicative of where to write and/or read first image data 608). The resetting of first image data 608 may be such that as new image data related to the first context (e.g., image data from the same sensor as first image data 608 or image data of the same type as first image data 608) will be written to first location 612 (e.g., potentially overwriting first image data 608 at first location 612). After resetting first image data 608, ISP 602 may process second image data 610 stored at second location 614 in memory 606 of ISP 602. For example, ISP 602 may continue processing second image data 610 despite having reset first image data 608.

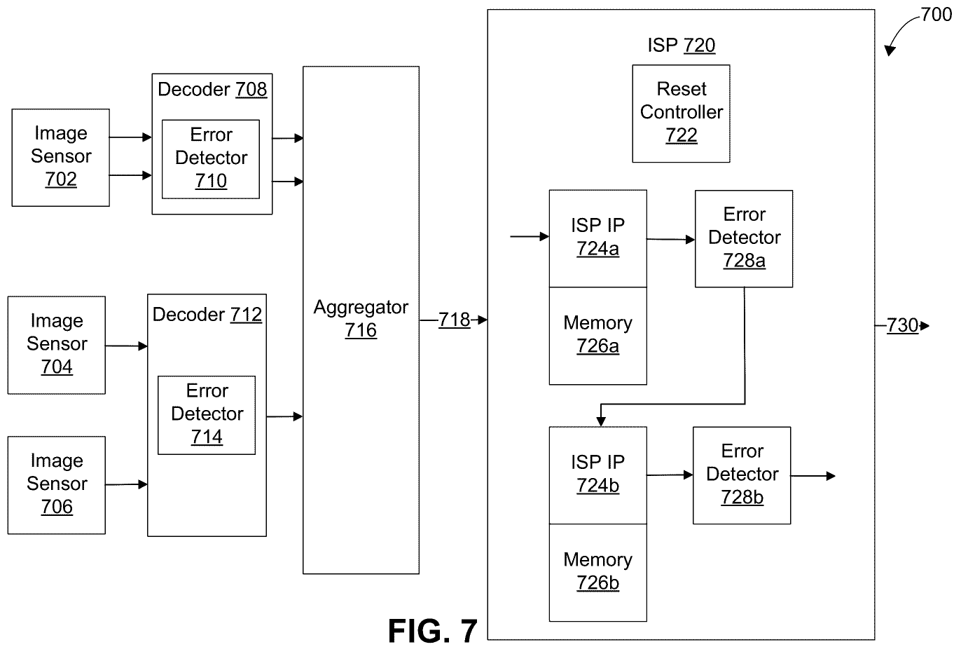

FIG. 7 is a diagram illustrating a system 700 for processing image data, according to various aspects of the present disclosure. System 700 includes an image-signal processor (ISP 720) configured to process image data of multiple contexts received in a data stream 718. System 700 also includes a reset controller 722 configured to, in response to a detected error related to image data of one of the contexts, reset the one context while maintaining other contexts being processed by ISP 602.

Data stream 718 may include data of one or more contexts. For example, data stream 718 may include multiple separate data sets from a single image sensor. For example, image sensor 702 may generate multiple sets of image data (e.g., image sensor 702 may be the same as, may be substantially similar to, and/or may perform the same, or substantially the same, operations as image sensor 202 of FIG. 2). Decoder 708 may decode the multiple sets of image data (e.g., decoder 708 may be the same as, may be substantially similar to, and/or may perform the same, or substantially the same, operations as decoder 208 of FIG. 2). Aggregator 716 may aggregate the decoded multiple sets of image data into data stream 718 (e.g., aggregator 716 may be the same as, may be substantially similar to, and/or may perform the same, or substantially the same, operations as aggregator 214 of FIG. 2). Aggregator 716 may tag each set of image data with a respective tag to differentiate one set of image data from another.

Additionally, or alternatively, data stream 718 may include data from two or more separate image sensors. For example, image sensor 704 and image sensor 706 may each generate a respective set of image data (e.g., image sensor 704 and image sensor 706 may be the same as, may be substantially similar to, and/or may perform the same, or substantially the same, operations as image sensor 222 and image sensor 226 respectively). Decoder 712 may decode the sets of image data (e.g., decoder 712 may be the same as, may be substantially similar to, and/or may perform the same, or substantially the same, operations as decoder 234). Aggregator 716 may aggregate the decoded sets of image data into data stream 718 (e.g., aggregator 716 may be the same as, may be substantially similar to, and/or may perform the same, or substantially the same, operations as aggregator 214 of FIG. 2).

ISP 720 may be an example of ISP 602 of FIG. 6. ISP 720 may process image data (as received in data stream 718) to generate processed image data 730. ISP 720 may perform operations such as Bayer transformations, demosaicing, noise reduction, and/or image sharpening.

ISP 720 may include multiple ISP intellectual property (IP) blocks. For example, ISP 720 may include ISP IP 724a and ISP IP 724b (which may be collectively referred to as ISP IP blocks 724). For simplicity, two ISP IP blocks 724 are illustrated in FIG. 7. ISP 720 may include any number of ISP IP blocks 724. Each of the ISP IP blocks may perform one or more operations on image data. For example, each of the ISP IP blocks 724 may perform scalar multiplication, scalar division, summation, filtering, etc. ISP 720 may process image data by sequentially processing the image data at each of ISP IP blocks 724.

Each of ISP IP blocks 724 may include, or may be associated with, a memory. For example, ISP IP 724a may include, or be associated with, memory 726a and ISP IP 724b May include, or may be associated with, memory 726b. Image data may be stored in memory 726a while, or for, ISP IP 724a to process the image data. Similarly, image data may be stored in memory 726b while, or for, ISP IP 724b to process the image data.

Reset controller 722 may be the same as, may be substantially similar to, and/or may perform the same, or substantially the same, operations as reset controller 604 of FIG. 6. Reset controller 722 may perform per-context resetting. For example, reset controller 722 may reset processing of first image data without affecting processing of second image data. For example, in response to an error detection related to the first image data, reset controller 722 may reset the first image data at in memory of ISP 720 (including in the respective memories of ISP IP blocks 724, such as memory 726a and memory 726b) while maintaining the second image data in the memory of ISP 720 (including in the respective memories of ISP IP blocks 724, such as memory 726a and memory 726b). Though not illustrated in FIG. 7, reset controller 722 may have a communicative connection to each of ISP IP blocks 724, or to the memories thereof (e.g., memory 726a and memory 726b).

Additionally, or alternatively, reset controller 722 may reset data in aggregator 716. For example, in response to an error detection related to the first image data, reset controller 722 may reset the first image data in aggregator 716 while maintaining the second image data in aggregator 716. For example, reset controller 722 may send a reset signal to aggregator 716. The reset signal may indicate resetting the first image data. Aggregator 716 may reset the first image data in a memory of aggregator 716 (e.g., a buffer) without resetting the second image data in the memory. Though not illustrated in FIG. 7, reset controller 722 may have a communicative connection to aggregator 716.

Additionally, or alternatively, reset controller 722 may reset data in decoder 708 and/or decoder 712. For example, in response to an error detection related to first image data received from decoder 708, reset controller 722 may reset the first image data in decoder 708 without affecting second image data in decoder 708. For example, reset controller 722 may send a reset signal to decoder 708. The reset signal may indicate resetting the first image data (e.g., the first image data received from image sensor 702). Decoder 708 may reset the first image data in a memory of decoder 708 (e.g., a buffer) without resetting the second image data (e.g., the second image data received from image sensor 702) in the memory of decoder 708. Though not illustrated in FIG. 7, reset controller 722 may have a communicative connection to decoder 708.

Further, in response to an error detection related to first image data received from decoder 712, reset controller 722 may reset first image data in decoder 712 without affecting second image data in decoder 712. For example, reset controller 722 may send a reset signal to decoder 712. The reset signal may indicate resetting the first image data (e.g., the image data received from image sensor 704). Decoder 708 may reset the first image data in a memory of decoder 708 (e.g., a buffer) without resetting the second image data (e.g., the image data received from image sensor 706) in the memory. Though not illustrated in FIG. 7, reset controller 722 may have a communicative connection to decoder 712.

In some cases, system 700 may include error detectors that may detect errors on a per-context basis. For example, system 700 may include an error detector for each decoder. The error detectors may detect errors related to sets of image data (e.g., sets of raw image data). For example, system 700 may include an error detector 710 for decoder 708. Error detector 710 may detect errors in sets of image data (e.g., raw image data) received from image sensor 702. Error detector 710 may independently detect errors related to each set of image data provided by image sensor 702. For example, if image sensor 702 provides two sets of image data, error detector 710 may independently detect errors related to each of the two sets of image data. Error detector 710 may report errors (on a per-context basis) to reset controller 722. Though not illustrated in FIG. 7, error detector 710 may have a communicative connection to reset controller 722.

As another example, system 700 may include an error detector 714 for decoder 712. Error detector 714 may detect errors in sets of image data (e.g., raw image data) received from image sensor 704 and from image sensor 706. Error detector 714 may independently detect errors related image data received from image sensor 704 and errors related to image data received from image sensor 706. Error detector 714 may report errors (on a per-context basis) to reset controller 722. Though not illustrated in FIG. 7, error detector 714 may have a communicative connection to reset controller 722.

Further, ISP 720 may include error detectors coupled to each of ISP IP blocks 724. For example, ISP 720 may include error detector 728a coupled to ISP IP 724a and error detector 728b coupled to ISP IP 724b. Error detector 728a and error detector 728b may be referred to collectively as error detectors 728. Each of error detectors 728 may observe a timing of operation of a respective one of ISP IP blocks 724. For example, error detector 728a may observe a timing of when ISP IP 724a outputs processed image data (e.g., processed by ISP IP 724a). If error detector 728a detects that the timing of ISP IP 724a processing the image data is unexpected (e.g., ISP IP 724a processes the image data too quickly or too slowly), error detector 728a may determine that an error has occurred. Based on tags on the image data, error detector 728a may correlate the error with a context. Each of error detectors 728 may report errors (on a per-context basis) to reset controller 722. Though not illustrated in FIG. 7, each of error detectors 728 may have a communicative connection to reset controller 722.

Additionally or alternatively, reset controller 722 may perform per-context resetting (e.g., responsive to a request). For example, another system may request, or instruct, system 700 to reset one or more processing image data of one or more contexts. Reset controller 722 may implement the resetting, on a per-context basis, responsive to the request. For example, a device including multiple cameras may be processing and displaying image data from a first camera. A user may request to display image data from a second camera instead of from the first camera. Reset controller 722 may receive a request to reset, or clear, the image data being processed from the first camera. Reset controller 722 may provide reset signals to memory 726a, memory 726b, aggregator 716, decoder 708, and/or decoder 712. The reset signals may refer image data of the first camera. Responsive to the reset signal, memory 726a, memory 726b, aggregator 716, decoder 708, and/or decoder 712 may reset image data from the first camera from their respective memories.

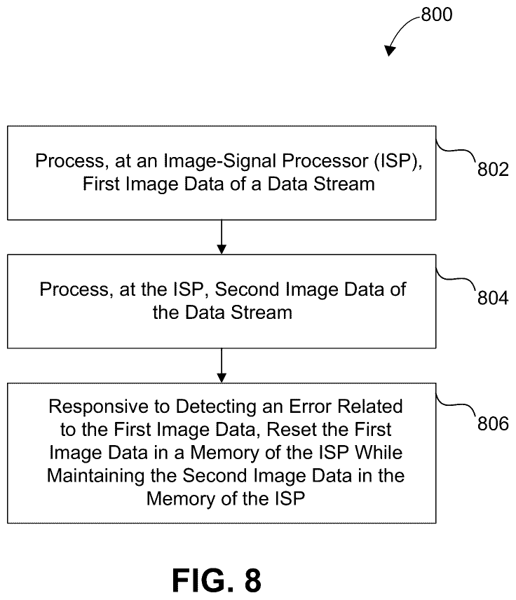

FIG. 8 is a flow diagram illustrating a process 800 for handling errors in an image processing system, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 800. The one or more operations of process 800 may be implemented as software components that are executed and run on one or more processors.

At a block 802, a computing device (or one or more components thereof) may process, at an image-signal processor (ISP), first image data of a data stream. For example, ISP 602 of system 600 of FIG. 6 may process first image data 608.

At a block 804, the computing device (or one or more components thereof) may process, at the ISP, second image data of the data stream. For example, ISP 602 of system 600 may process second image data 610.

At a block 806, the computing device (or one or more components thereof) may responsive to detecting an error related to the first image data, reset the first image data in a memory of the ISP while maintaining the second image data in the memory of the ISP. For example, system 600 may reset first image data 608 in memory 606 of ISP 602 while maintaining second image data 610 in memory 606 of ISP 602.

In some aspects, the computing device (or one or more components thereof) may receive the first image data of the data stream; store the first image data at a first location in a memory of the ISP; process the first image data from the first location in the memory of the ISP; receive the second image data of the data stream; store the second image data at a second location in the memory of the ISP; and process the second image data from the second location in the memory of the ISP. For example, ISP 602 may receive image data 608a in data stream 616, store image data 608a at first location 612 of memory 606, and process image data 608a from first location 612 in memory 606. Further, ISP 602 may receive image data 610a in data stream 616, store image data image data 610a at second location 614 of memory 606, and process image data 610a from second location 614 in memory 606. In some aspects, resetting the first image data in the memory of the ISP while maintaining the second image data in the memory of the ISP may include resetting the first image data at the first location in the memory of the ISP while maintaining the second image data at the second location in the memory of the ISP. For example, resetting the first image data, at block 806 may include resetting image data 610a at first location 612 of memory 606 while maintaining image data 610a at second location 614 of memory 606.

In some aspects, the computing device (or one or more components thereof) may process the second image data stored at the second location in the memory of the ISP subsequent to resetting the first image data in the memory of the ISP. For example, ISP 602 may process image data 610a at second location 614 of memory 606 subsequent to ISP 602 resetting image data 608a at first location 612 of memory 606.

In some aspects, resetting the first location of the memory (e.g., at block 806) may include resetting an offset corresponding to the first location. For example, ISP 602 may reset an offset corresponding to first location 612 in memory 606.

In some aspects, processing the first image data and the second image data at the ISP (e.g., at block 802 and block 804) may include processing the first image data and the second image data at one or more ISP intellectual property (IP) blocks of the ISP. For example, processing the image data at ISP 720 may include processing the image data at one or more instances of ISP IP blocks 724 (e.g., ISP IP 724a and/or ISP IP 724b). In some aspects, resetting the first image data in memory of the ISP (e.g., at block 806) may include resetting the first image data stored by each of the one or more ISP IP blocks. For example, resetting the image data may include resetting the image data at one or more instances of memory 726 (e.g., memory 726a and/or memory 726b). In some aspects, the computing device (or one or more components thereof) may detect errors based on a delay in processing the first image data at the one or more ISP IP blocks. For example, ISP 720 may detect errors using one or more instances of error detectors 728 (e.g., error detector 728a and/or error detector 728b).

In some aspects, the computing device (or one or more components thereof) may reset the first image data at a first location in the memory of the ISP; and after resetting the first image data at the first location, overwriting the first image data at the first location with third image data. For example, ISP 602 may reset image data 608a at first location 612 in memory 606. After resetting image data 608a, ISP 602 may write other image data in first location 612. For example, there may be an error related to first image data 608. Responsive to detecting the error, ISP 602 may reset all of first image data 608 in memory 606. Subsequent to resetting first image data 608 in memory 606, ISP 602 may receive other image data (e.g., from the same source). ISP 602 May overwrite any portion of first image data 608 that is leftover at first location 612 of memory 606 with the other data.

In some aspects, the computing device (or one or more components thereof) may detect the error related to the first image data. For example, system 700 of FIG. 7 may include error detector 710, error detector 714, and/or one or more instances of error detectors 728 (e.g., error detector 728a, and/or error detector 728b). Any or all of error detector 710, error detector 714, and error detectors 728 may detect the error and ISP 720 may reset image data in a memory of ISP 720 responsive to the detected error.

In some aspects, the computing device (or one or more components thereof) may receive raw image data; generating the first image data based on the raw image data; and detecting errors based on the raw image data. For example, the image data received at block 802 and block 804 may be raw image data. For example, first image data 608 and second image data 610 may be raw image data. Further, ISP 602 may generate processed image data 618 based on first image data 608 and/or second image data 610. Further, ISP 602 may detect errors related to first image data 608 and/or second image data 610. For example, system 600 may include one or more error detectors (e.g., error detector 710, error detector 714, and one or more instances of error detectors 728).

In some examples, as noted previously, the methods described herein (e.g., process 800 of FIG. 8 and/or other methods described herein) can be performed, in whole or in part, by a computing device or apparatus. In one example, one or more of the methods can be performed by image-processing system 100 of FIG. 1, image-processing device 104 of FIG. 1, image processor 124 of FIG. 1, system 200 of FIG. 2, system 600 of FIG. 6, system 700 of FIG. 7, or by another system or device. In another example, one or more of the methods (e.g., process 800 of FIG. 8 and/or other methods described herein) can be performed, in whole or in part, by the computing-device architecture 900 shown in FIG. 9. For instance, a computing device with the computing-device architecture 900 shown in FIG. 9 can include, or be included in, the components of the image-processing system 100 of FIG. 1, image-processing device 104 of FIG. 1, image processor 124 of FIG. 1, system 200 of FIG. 2, system 600 of FIG. 6, system 700 of FIG. 7 and can implement the operations of process 800 and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 800 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Process 800 and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 9 illustrates an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, implement, or be included in any or all of image-processing system 100 of FIG. 1, image-processing device 104 of FIG. 1, image processor 124 of FIG. 1, system 200 of FIG. 2, system 600 of FIG. 6, system 700 of FIG. 7.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

Computing-device architecture 900 can include a cache of high-speed memory connected directly with, in close proximity to, or integrated as part of processor 902. Computing-device architecture 900 can copy data from memory 910 and/or the storage device 914 to cache 904 for quick access by processor 902. In this way, the cache can provide a performance boost that avoids processor 902 delays while waiting for data. These and other modules can control or be configured to control processor 902 to perform various actions. Other computing device memory 910 may be available for use as well. Memory 910 can include multiple different types of memory with different performance characteristics. Processor 902 can include any general-purpose processor and a hardware or software service, such as service 1 916, service 2 918, and service 3 920 stored in storage device 914, configured to control processor 902 as well as a special-purpose processor where software instructions are incorporated into the processor design. Processor 902 may be a self-contained system, containing multiple cores or processors, a bus, memory controller, cache, etc. A multi-core processor may be symmetric or asymmetric.

To enable user interaction with the computing-device architecture 900, input device 922 can represent any number of input mechanisms, such as a microphone for speech, a touch-sensitive screen for gesture or graphical input, keyboard, mouse, motion input, speech and so forth. Output device 924 can also be one or more of a number of output mechanisms known to those of skill in the art, such as a display, projector, television, speaker device, etc. In some instances, multimodal computing devices can enable a user to provide multiple types of input to communicate with computing-device architecture 900. Communication interface 926 can generally govern and manage the user input and computing device output. There is no restriction on operating on any particular hardware arrangement and therefore the basic features here may easily be substituted for improved hardware or firmware arrangements as they are developed.

Storage device 914 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 906, read only memory (ROM) 908, and hybrids thereof. Storage device 914 can include services 916, 918, and 920 for controlling processor 902. Other hardware or software modules are contemplated. Storage device 914 can be connected to the computing device connection 912. In one aspect, a hardware module that performs a particular function can include the software component stored in a computer-readable medium in connection with the necessary hardware components, such as processor 902, connection 912, output device 924, and so forth, to carry out the function.

The term “substantially.” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A. B, and C” or “at least one of A, B, or C” means A, B, C, or A and B, or A and C, or B and C. or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to.” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core), or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing image data, the apparatus comprising: an image-signal processor (ISP) configured to process first image data of a data stream and to process second image data of the data stream; and a reset controller configured to, in response to a detected error related to the first image data, reset the first image data in a memory of the ISP while maintaining the second image data in the memory of the ISP.

Aspect 2. The apparatus of aspect 1, wherein the ISP is configured to: receive the first image data of the data stream; store the first image data at a first location in a memory of the ISP; process the first image data from the first location in the memory of the ISP; receive the second image data of the data stream; store the second image data at a second location in the memory of the ISP; and process the second image data from the second location in the memory of the ISP.

Aspect 3. The apparatus of aspect 2, wherein the reset controller is configured to reset the first image data at the first location in the memory of the ISP while maintaining the second image data at the second location in the memory of the ISP.

Aspect 4. The apparatus of any one of aspects 2 or 3, wherein the ISP is configured to process the second image data stored at the second location in the memory of the ISP subsequent to the reset controller resetting the first image data in the memory of the ISP.

Aspect 5. The apparatus of any one of aspects 2 to 4, wherein, to reset the first image data in the memory of the ISP, the reset controller is configured to reset an offset corresponding to the first location.

Aspect 6. The apparatus of any one of aspects 1 to 5, wherein the ISP is configured to process the second image data subsequent to the reset controller resetting the first image data in the memory of the ISP.

Aspect 7. The apparatus of any one of aspects 1 to 6, wherein: to reset the first image data in the memory of the ISP, the reset controller is configured to reset the first image data at a first location in the memory of the ISP; and after the reset controller resets the first image data at the first location in the memory of the ISP, the ISP is configured to write third image data at the first location.

Aspect 8. The apparatus of any one of aspects 1 to 7, wherein the ISP comprises one or more ISP intellectual property (IP) blocks.

Aspect 9. The apparatus of aspect 8, wherein, to reset the first image data in memory of the ISP, the reset controller is configured to reset the first image data stored by each of the one or more ISP IP blocks.

Aspect 10. The apparatus of any one of aspects 8 or 9, wherein the ISP comprises one or more error detectors and wherein each of the one or more error detectors is coupled to a corresponding one of the one or more ISP IP blocks.

Aspect 11. The apparatus of aspect 10, wherein each of the one or more error detectors is configured to detect a respective error based on a respective delay in processing image data at a respective one of the one or more ISP IP blocks.

Aspect 12. The apparatus of any one of aspects 1 to 11, wherein the ISP comprises an error detector configured to detect errors based on delays in processing image data.

Aspect 13. The apparatus of aspect 12, wherein the reset controller is configured to, responsive to a detected error related to the second image data, reset the second image data in memory of the ISP while maintaining the first image data in the memory of the ISP.

Aspect 14. The apparatus of any one of aspects 1 to 13, wherein: the apparatus comprises a first camera decoder configured to generate the first image data based on first raw image data; and the first camera decoder comprises an error detector configured to detect errors related to the first raw image data.

Aspect 15. The apparatus of aspect 14, wherein: the apparatus further comprises a second camera decoder configured to generate the second image data based on second raw image data; the second camera decoder comprises a second error decoder configured to detect an error related to the second image data; and the reset controller is configured to, responsive to a detected error related to the second image data, reset the second image data in memory of the ISP while maintaining the first image data in the memory of the ISP.

Aspect 16. The apparatus of any one of aspects 1 to 15, wherein: the apparatus further comprises a first camera decoder configured to generate the first image data based on first raw image data; and the reset controller is configured to, responsive to a detected error related to the first image data, reset the first image data at the first camera decoder.

Aspect 17. The apparatus of any one of aspects 1 to 16, wherein: the apparatus further comprises an aggregator configured to aggregate the first image data and the second image data into the data stream; and the reset controller is configured to, responsive to a detected error related to the first image data, reset the first image data at context aggregator while maintaining the second image data at context aggregator.

Aspect 18. The apparatus of any one of aspects 1 to 17, wherein the reset controller is configured to, responsive to a reset command, at least one of: reset the first image data in memory of the ISP while maintaining the second image data in the memory of the ISP; reset the second image data in memory of the ISP while maintaining the first image data in the memory of the ISP; or reset the first image data and the second image data in the ISP.

Aspect 19. The apparatus of any one of aspects 1 to 18, further comprising: a sensor-data aggregator configured aggregate first raw image data and second raw image data into third raw image data; and a first camera decoder configured to generate the first image data based on the third raw image data.

Aspect 20. A method for processing image data, the method comprising: processing, at an image-signal processor (ISP), first image data of a data stream; processing, at the ISP, second image data of the data stream; and responsive to detecting an error related to the first image data, resetting the first image data in a memory of the ISP while maintaining the second image data in the memory of the ISP.

Aspect 21. The method of aspect 20, further comprising: receiving the first image data of the data stream; storing the first image data at a first location in a memory of the ISP; processing the first image data from the first location in the memory of the ISP; receiving the second image data of the data stream; storing the second image data at a second location in the memory of the ISP; and processing the second image data from the second location in the memory of the ISP.

Aspect 22. The method of aspect 21, wherein, resetting the first image data in the memory of the ISP while maintaining the second image data in the memory of the ISP comprises resetting the first image data at the first location in the memory of the ISP while maintaining the second image data at the second location in the memory of the ISP.

Aspect 23. The method of any one of aspects 21 or 22, further comprising processing the second image data stored at the second location in the memory of the ISP subsequent to resetting the first image data in the memory of the ISP.

Aspect 24. The method of any one of aspects 21 to 23, wherein resetting the first location of the memory comprises resetting an offset corresponding to the first location.

Aspect 25. The method of any one of aspects 20 to 24, further comprising: resetting the first image data at a first location in the memory of the ISP; and after resetting the first image data at the first location, overwriting the first image data at the first location with third image data.

Aspect 26. The method of any one of aspects 20 to 25, further comprising detecting the error related to the first image data.

Aspect 27. The method of any one of aspects 20 to 26, wherein processing the first image data and the second image data at the ISP comprises processing the first image data and the second image data at one or more ISP intellectual property (IP) blocks of the ISP.

Aspect 28. The method of aspect 27, wherein resetting the first image data in memory of the ISP comprises resetting the first image data stored by each of the one or more ISP IP blocks.

Aspect 29. The method of any one of aspects 27 or 28, further comprising detecting errors based on a delay in processing the first image data at the one or more ISP IP blocks.

Aspect 30. The method of any one of aspects 20 to 29, further comprising: receiving raw image data; generating the first image data based on the raw image data; and detecting errors based on the raw image data.

Aspect 31. A non-transitory computer-readable storage medium having stored thereon instructions that, when executed by at least one processor, cause the at least one processor to perform operations according to any of aspects 20 to 30.

Aspect 32. An apparatus for providing virtual content for display, the apparatus comprising one or more means for perform operations according to any of aspects 20 to 30.

What is claimed is:

1. An apparatus for processing image data, the apparatus comprising:
an image-signal processor (ISP) configured to process first image data of a data stream and to process second image data of the data stream; and
a reset controller configured to, in response to a detected error related to the first image data, reset the first image data in a memory of the ISP while maintaining the second image data in the memory of the ISP.

2. The apparatus of claim 1, wherein the ISP is configured to:
receive the first image data of the data stream;
store the first image data at a first location in a memory of the ISP;
process the first image data from the first location in the memory of the ISP;
receive the second image data of the data stream;
store the second image data at a second location in the memory of the ISP; and
process the second image data from the second location in the memory of the ISP.

3. The apparatus of claim 2, wherein the reset controller is configured to reset the first image data at the first location in the memory of the ISP while maintaining the second image data at the second location in the memory of the ISP.

4. The apparatus of claim 2, wherein the ISP is configured to process the second image data stored at the second location in the memory of the ISP subsequent to the reset controller resetting the first image data in the memory of the ISP.

5. The apparatus of claim 2, wherein, to reset the first image data in the memory of the ISP, the reset controller is configured to reset an offset corresponding to the first location.

6. The apparatus of claim 1, wherein the ISP is configured to process the second image data subsequent to the reset controller resetting the first image data in the memory of the ISP.

7. The apparatus of claim 1, wherein:
to reset the first image data in the memory of the ISP, the reset controller is configured to reset the first image data at a first location in the memory of the ISP; and
after the reset controller resets the first image data at the first location in the memory of the ISP, the ISP is configured to write third image data at the first location.

8. The apparatus of claim 1, wherein the ISP comprises one or more ISP intellectual property (IP) blocks.

9. The apparatus of claim 8, wherein, to reset the first image data in memory of the ISP, the reset controller is configured to reset the first image data stored by each of the one or more ISP IP blocks.

10. The apparatus of claim 8, wherein the ISP comprises one or more error detectors and wherein each of the one or more error detectors is coupled to a corresponding one of the one or more ISP IP blocks.

11. The apparatus of claim 10, wherein each of the one or more error detectors is configured to detect a respective error based on a respective delay in processing image data at a respective one of the one or more ISP IP blocks.

12. The apparatus of claim 1, wherein the ISP comprises an error detector configured to detect errors based on delays in processing image data.

13. The apparatus of claim 12, wherein the reset controller is configured to, responsive to a detected error related to the second image data, reset the second image data in memory of the ISP while maintaining the first image data in the memory of the ISP.

14. The apparatus of claim 1, wherein:
the apparatus comprises a first camera decoder configured to generate the first image data based on first raw image data; and
the first camera decoder comprises an error detector configured to detect errors related to the first raw image data.

15. The apparatus of claim 14, wherein:
the apparatus further comprises a second camera decoder configured to generate the second image data based on second raw image data;
the second camera decoder comprises a second error decoder configured to detect an error related to the second image data; and
the reset controller is configured to, responsive to a detected error related to the second image data, reset the second image data in memory of the ISP while maintaining the first image data in the memory of the ISP.

16. The apparatus of claim 1, wherein:
the apparatus further comprises a first camera decoder configured to generate the first image data based on first raw image data; and
the reset controller is configured to, responsive to a detected error related to the first image data, reset the first image data at the first camera decoder.

17. The apparatus of claim 1, wherein:
the apparatus further comprises an aggregator configured to aggregate the first image data and the second image data into the data stream; and
the reset controller is configured to, responsive to a detected error related to the first image data, reset the first image data at context aggregator while maintaining the second image data at context aggregator.

18. The apparatus of claim 1, wherein the reset controller is configured to, responsive to a reset command, at least one of:
reset the first image data in memory of the ISP while maintaining the second image data in the memory of the ISP;
reset the second image data in memory of the ISP while maintaining the first image data in the memory of the ISP; or
reset the first image data and the second image data in the ISP.

19. The apparatus of claim 1, further comprising:
a sensor-data aggregator configured aggregate first raw image data and second raw image data into third raw image data; and
a first camera decoder configured to generate the first image data based on the third raw image data.

20. A method for processing image data, the method comprising:
processing, at an image-signal processor (ISP), first image data of a data stream;
processing, at the ISP, second image data of the data stream; and
responsive to detecting an error related to the first image data, resetting the first image data in a memory of the ISP while maintaining the second image data in the memory of the ISP.

21. The method of claim 20, further comprising:
receiving the first image data of the data stream;
storing the first image data at a first location in a memory of the ISP;
processing the first image data from the first location in the memory of the ISP;
receiving the second image data of the data stream;
storing the second image data at a second location in the memory of the ISP; and
processing the second image data from the second location in the memory of the ISP.

22. The method of claim 21, wherein, resetting the first image data in the memory of the ISP while maintaining the second image data in the memory of the ISP comprises resetting the first image data at the first location in the memory of the ISP while maintaining the second image data at the second location in the memory of the ISP.

23. The method of claim 21, further comprising processing the second image data stored at the second location in the memory of the ISP subsequent to resetting the first image data in the memory of the ISP.

24. The method of claim 21, wherein resetting the first location of the memory comprises resetting an offset corresponding to the first location.

25. The method of claim 20, further comprising:
resetting the first image data at a first location in the memory of the ISP; and
after resetting the first image data at the first location, overwriting the first image data at the first location with third image data.

26. The method of claim 20, further comprising detecting the error related to the first image data.

27. The method of claim 20, wherein processing the first image data and the second image data at the ISP comprises processing the first image data and the second image data at one or more ISP intellectual property (IP) blocks of the ISP.

28. The method of claim 27, wherein resetting the first image data in memory of the ISP comprises resetting the first image data stored by each of the one or more ISP IP blocks.

29. The method of claim 27, further comprising detecting errors based on a delay in processing the first image data at the one or more ISP IP blocks.

30. The method of claim 20, further comprising:
receiving raw image data;
generating the first image data based on the raw image data; and
detecting errors based on the raw image data.
